(19) United States
(12) Patent Application Publication
(10) Pub. No.: US 2024/0417237 A1
(43) Pub. Date: Dec. 19, 2024

(54) AERATING NOZZLE FOR TAP

(71) Applicant: BE WTR SA, Lausanne (CH)

(72) Inventors: Antoine Cahen, Lausanne (CH); Jean-Luc Denisart, Cully (CH); Etienne Lebreton, Crissier (CH)

(73) Assignee: BE WTR SA, Lausanne (CH)

(21) Appl. No.: 18/705,923

(22) PCT Filed: Aug. 29, 2022
(86) PCT No.: PCT/IB2022/058076

§ 371 Date: Apr. 29, 2024

(30) Foreign Application Priority Data
Aug. 27, 2021 (CH) 070208/2021

(51) Int. Cl. B67D 1/12; B67D 1/14

(52) U.S. Cl. CPC B67D 1/1275; B67D 1/1455

(57) ABSTRACT

The present invention concerns a tap nozzle (2) comprising: •—a nozzle inlet (21) arranged to be connected to a tap outlet for allowing a liquid to flow from the tap outlet into the nozzle (2); •—a nozzle outlet (22) in fluid communication with the nozzle inlet (21) and arranged to allow the liquid to flow out from the nozzle, so as to form a liquid flow circuit; •—a paddle wheel (23) rotatably mounted between the nozzle inlet and the nozzle outlet around a flow axis determined by the flow of the liquid in the nozzle, the paddle wheel comprising a plurality of fins (230) extending radially from the flow axis; •—a planar grid (24) disposed between the paddle wheel (23) and the nozzle outlet (22) in a plane transverse to the to flow axis; an air flow circuit allowing an air flow to circulate from the exterior of the nozzle to the interior of the nozzle so as to maximize the liquid oxygenation in the nozzle, the air flow circuit being at least partially distinct from the liquid flow circuit.

### TECHNICAL DOMAIN

The present invention concerns a tap nozzle allowing an increased oxygenation of the liquid dispensed by a tap.

### RELATED ART

Taps allowing the dispensing of different types of liquids are usually called n-way taps, according to the number “n” of liquids that can be dispensed.

Dispensing multiple types of liquids is an essential feature of standard taps. The most obvious example is the hot/cold water configuration, but other important examples include
still/sparkling water,
chilled/ambient water,
filtrated/wash and dish water,
standard/boiling water,
soda/water of different types of sodas,
different types of beers,
etc. . . .

Cold and hot water are usually both coming from the same pipe. There is no problem to mix them in the tap extremity. On the contrary, filtrated drinking water and standard tap water have different composition and properties due to the filter. They need to have separate nozzles for avoiding to mix them.

There are two different opening systems for such taps. On one hand, stable openings allow to regulate the intensity of the liquid flow, while on the other hand, so called temporized taps provide a liquid flow in a 1-0 manner, meaning that the flow intensity cannot be chosen.

Another type of taps is provided by beer taps for dispensing draught beer. The opening of such taps is usually commanded by handles that were initially designed for actioning pumps. They have been progressively replaced by handles actioning normally closed valves for sparing beer. These valves usually 1-0 valves in order to optimize the flow to avoid foam excess. Moreover, there are often several nozzles for the different types of beer, and the taps are optionally chilled by a recirculation pump for offering an optimal beer temperature.

Document WO2011008491A1 discloses a tap that allows at least three streams of draught beers to be dispersed from one keg handle. The handle commands valves associated to the different type of draught beers. The choice of the valve to be opened is made by rotating the handle around the handle axis and the opening of the corresponding valve is made by rotating the handle around a fixed point. Two different rotations are therefore needed to choose and open a valve. Moreover, the tap is limited to beer keg and is not meant to be placed on other systems such as domestic water distribution networks.

All the abovementioned taps may be equipped with different types of nozzles that can serve for example to spare water, redirect or increase/decrease a liquid flow. In particular, tap nozzles may be used to increase the aeration of a liquid flowing out of a tap.

When the liquid of interest is water, aeration may be a key factor in view of an activation of the water. By an activation of the water, it is meant that the water is submitted to specific electromagnetic field in order to obtain a good homogeneity of dissolved gasses and minerals, minimizing therefore the propension of the water to form calcification deposit.

Indeed, when submitted to certain electromagnetic fields, water is agitated at a molecular level by the fact that H₂O molecules are attracted by the field but not the other water components. This creates a molecular “shake” that enhance water homogeneity with impact on nanobubbles, and water molecule clusters. The water activation supposes the application of specific electromagnetic fields on a water which is rich in minerals and well aerated.

Water networks have usually a low dissolved air concentration for several reasons such as the succession of pumps, tubes angles, and temperature and pressure variations which tend to degas the water.

The question of the hygienic environment of the liquid dispensed by a tap can be of high importance, for example if the dispensed liquid is destinated to the consumption. Aerosols contaminate consumer hands and consumer hands accessible surfaces.

There is therefore a need for tap nozzles maximizing the liquid aeration.

There is also a need for tap nozzles guaranteeing a high hygiene level during standard use, washing and maintenance. In particular, there is a need for tap nozzles where the liquid outlet is prevented from possible consumer hand contact.

### SHORT DISCLOSURE OF THE INVENTION

An aim of the present invention is to provide oxygenation nozzle that overcomes the shortcomings and limitations of the state of the art.

Another aim of the invention is to provide a tap nozzle that increase the aeration of a liquid flowing through it.

Another aim of the invention is to provide a tap nozzle guaranteeing a high hygiene level.

According to the invention, these aims are attained by the object of the attached claims, and especially by a tap nozzle comprising
a nozzle inlet arranged to be connected to a tap outlet for allowing a liquid to flow from the tap outlet into the nozzle;
a nozzle outlet in fluid communication with the nozzle inlet and arranged to allow the liquid to flow out from the nozzle, so as to form a liquid flow circuit;
a paddle wheel rotatably mounted between the nozzle inlet and the nozzle outlet around a flow axis determined by the flow of the liquid in the nozzle, the paddle wheel comprising a plurality of fins extending radially from the flow axis;
a planar grid disposed between the paddle wheel and the nozzle outlet in a plane transverse to the to flow axis;
an air flow circuit allowing an air flow to circulate from the exterior of the nozzle to the interior of the nozzle so as to maximize the liquid oxygenation in the nozzle, the air flow circuit being at least partially distinct from the liquid flow circuit.

The air flow circuit may be at least partially disposed between an internal surface of the nozzle and an outer lateral surface of the paddle wheel and/or an outer lateral surface of the planar grid.

The air flow circuit may comprise an air flow inlet distinct from the nozzle outlet. This means that the air circulating in the nozzle is not simply entering through the nozzle outlet.

The air flow inlet may comprise at least one hole in an outer lateral surface of the nozzle.

The tap nozzle may further comprise at least one air flow outlet disposed internally to the nozzle.

The tap nozzle may further comprise a nozzle housing. Such a housing is meant to minimize the contamination risk of the interior of the nozzle with external agent.

The tap nozzle may further comprise an O-ring disposed between an outer lateral surface of the nozzle and an inner lateral surface of the nozzle housing.

The fins of the paddle wheel may be slanted.

The planar grid may be rotatably mounted around the flow axis.

The planar grid may comprise fins, slanted or not.

The paddle wheel and the planar grid may be integral one with each other.

The tap nozzle may further comprise a funnel disposed between the planar grid and the nozzle outlet so that an aperture of the funnel having the largest diameter faces the planar grid and an opposite aperture of the funnel having the smallest diameter faces the nozzle outlet.

The tap nozzle may further comprise a liquid flow director for directing the liquid flowing out of the tap nozzle.

The tap nozzle may further comprise a plurality of slots on an outer lateral surface of the nozzle.

### SHORT DESCRIPTION OF THE DRAWINGS

Exemplar embodiments of the invention are disclosed in the description and illustrated by the drawings in which:

FIG. 1 illustrates a tap with an oxygenation nozzle.

FIG. 2 illustrates a tap with an oxygenation nozzle in exploded view.

FIG. 3 illustrates a frontal cross section of a tap with an oxygenation nozzle.

FIG. 4 illustrates a perspective view of a frontal cross section of a tap with an oxygenation nozzle.

FIG. 5 illustrates a perspective view of an oxygenation nozzle.

FIG. 6 illustrates an exploded view of an oxygenation nozzle

FIG. 7a illustrates several components of an oxygenation nozzle including a paddle wheel.

FIG. 7b illustrates a cross section of an oxygenation nozzle

FIG. 8 illustrates a frontal cross section of a tap with an oxygenation nozzle.

FIG. 9 illustrates a tap with a handle in a first open position.

FIG. 10 illustrates a tap with a handle in a closed position.

FIG. 11 illustrates a tap with a handle in a second open position.

FIG. 12 illustrates a vertical cross section of a tap with two liquids inlets.

FIG. 13 illustrates a three quarter view of a vertical cross section of a tap with two liquids inlets.

FIG. 14 illustrates a vertical eccentric cross section of a tap with a handle in a closed position.

FIG. 15 illustrates the same vertical eccentric cross section as the one of FIG. 14 with the handle in the second open position.

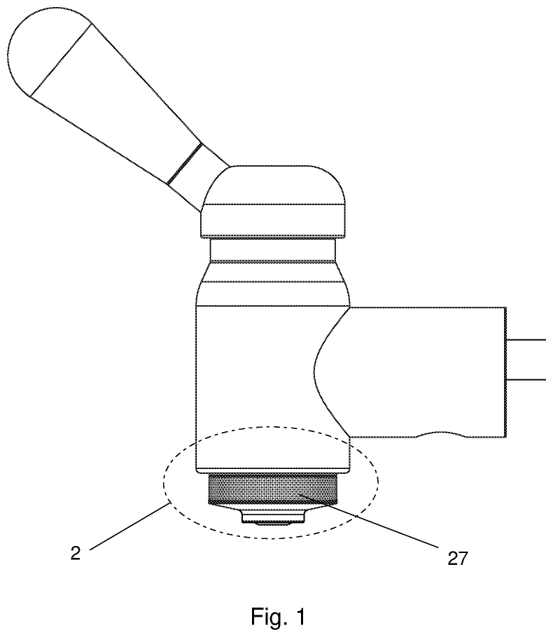

### EXAMPLES OF EMBODIMENTS OF THE PRESENT INVENTION

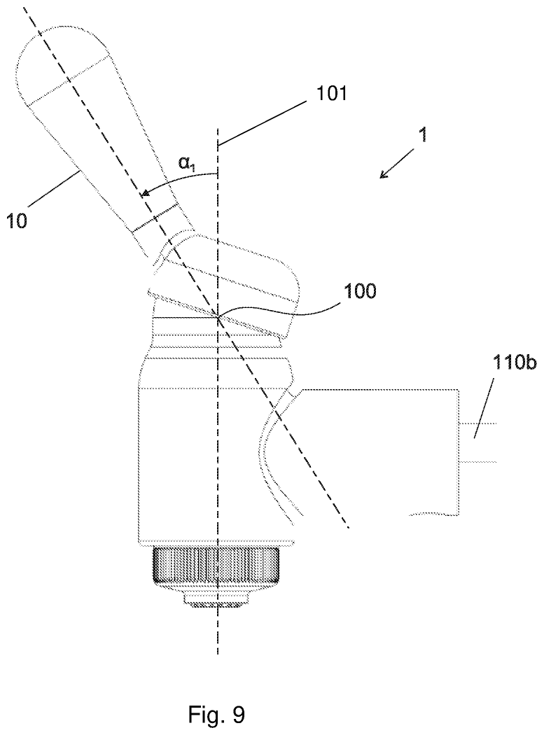

FIGS. 9-11 illustrate a tap 1 for dispensing alternatively two liquids such as for example still and sparkling water, or chilled and ambient water. Although this disclosure refers sometimes to water for brevity, it is intended that the present embodiments may be configured or intended for dispensing any type of beverages, water-based or not, and more generally, any type of liquid.

The two liquids that are to be dispensed are brought to the tap via two separated pipes. In particular, the tap 1 comprises a first inlet 11a connected to a first pipe 110a which brings a first liquid into the tap, and a second inlet 11b connected to a second pipe 110b which brings a second liquid into the tap.

The first and second pipes may be connected to any type of liquid source such as for example a water distribution network, a dedicated beverage distribution network, any liquid tank, pressurized or not, such as a beer keg or an insulated chilled water tank.

The tap 1 also comprises a first outlet 12a for outflowing the first liquid, and a second outlet 12b for outflowing the second liquid.

A nozzle may be equipped on the first and second outlets of the tap so as to gather the flow of the first and second liquid into a single flowout. Other types of nozzles such as for example filter nozzles or water saving nozzles may be mounted on the tap.

The tap 1 comprises a handle 10 which can be placed by a user in three distinct positions corresponding to the three flowing states of the tap. The handle is moved by rotation around a centre point 100. This rotation is operated preferably operated in a vertical plane, but other configurations in which the handle is able to rotate in an arbitrary plane are not excluded. In the present disclosure, the term “vertical” refers to its commonly accepted definition when the tap is in working order.

In the embodiment illustrated in the FIGS. 9-11, the handle 10 is able to rotate around a centre point 100 and the rotation is operated in a vertical plane comprising a reference axis 101 which passes through the centre point. This configuration of the handle is meant to mimic the standard configuration of beer dispensers. The different positions of the handle correspond to different angles measured between the reference axis and the handle in angular degrees.

In FIG. 9, the handle 10 of the tap 1 is placed in a first open position in which a first liquid can flow out of the tap and be dispensed. This first open position is determined by the angle α₁ between the reference axis and the handle.

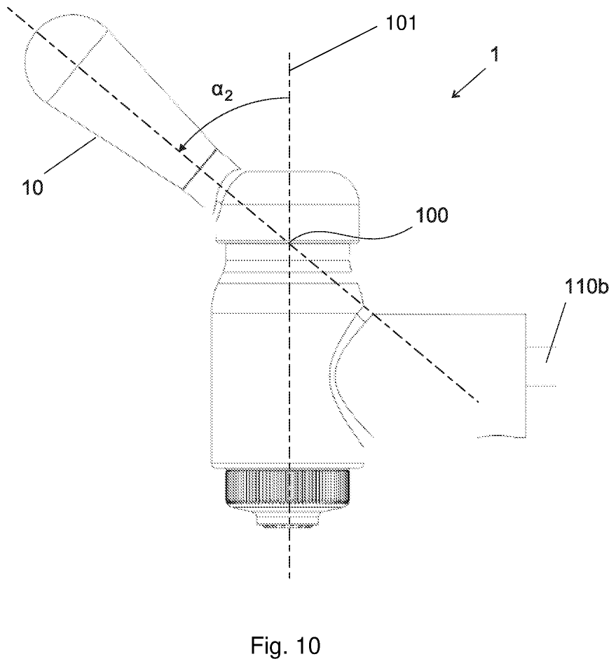

In FIG. 10, the handle 10 of the tap 1 is placed in a closed position in which no liquid can flow out of the tap. The closed position is determined by the angle α₂ between the reference axis and the handle. The angle α₂ is greater than α₁ so that a user has to push the handle up to pass from the closed position to the first open position.

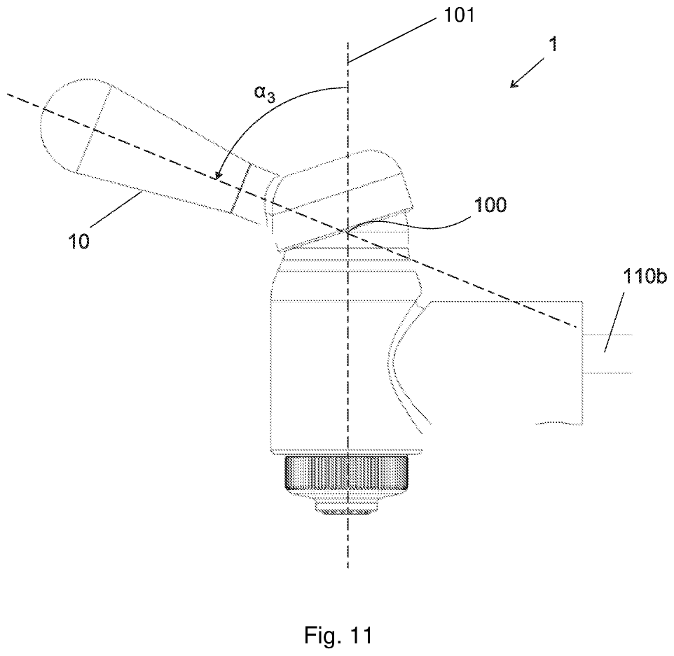

In FIG. 11, the handle 10 of the tap 1 is placed in a second open position in which a second liquid can flow out of the tap and be dispensed. This second open position is determined by the angle α₃ between the reference axis and the handle. The angle α₃ is greater than α₂ so that a user has to push the handle down to pass from the closed to the second open position.

The first angle α₁ may takes value between 25° and 35°, and preferably around 30°. The second angle α₂, which is greater than the first angle, may take values between 40° and 50°, and preferably around 45°. The third angle α₃, which is greater than the second angle, and therefore than the first angle, may take value between 55° and 65°, and preferably around 60°.

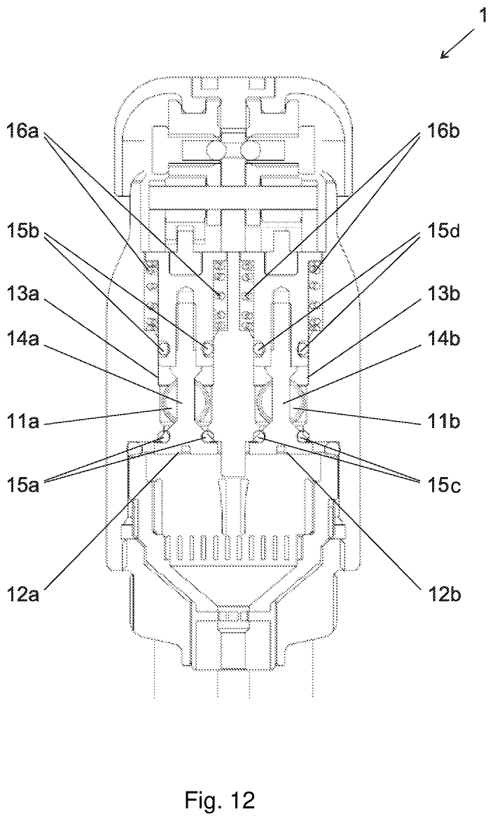

In an embodiment illustrated in FIG. 12, the handle 10 actuates a first piston 14a disposed in a first chamber 13a and a second piston 14b disposed in a second chamber 13b. The first chamber is in fluid communication with the first inlet The first piston commands the flow of the first liquid and the second piston commands the flow of the second liquid.

When the handle is in the closed position, the first piston 14a obstructs the first outlet 12a and the second piston 14b obstructs the second outlet 12b so that neither the first nor the second liquid can flow out the tap.

When the handle 10 is placed in the first open position, the first piston 14a is pushed down so that the first liquid can flow out through the first outlet 12a, while the second piston 14b is not moved with respect to his position when the handle is in the closed position so that the second liquid is prevented from flowing through the second outlet 12b.

Similarly, when the handle 10 is placed in the second open position, the second piston 14b is pushed down so that the second liquid can flow out through the second outlet 12b, while the first piston 14a is not moved with respect to his position when the handle is in the closed position so that the first liquid is prevented from flowing through the first outlet 12a.

The transmission of the handle movement to the first and second piston can be made by a toggle mechanism which allows a transformation of the rotation of the handle 10 around the centre point 100 into a linear movement of the two pistons. This toggle mechanism may comprise, for each of the first and second piston, an upper plate and a lower plate which are fixed together around a pivot forming therefore a double pendulum system.

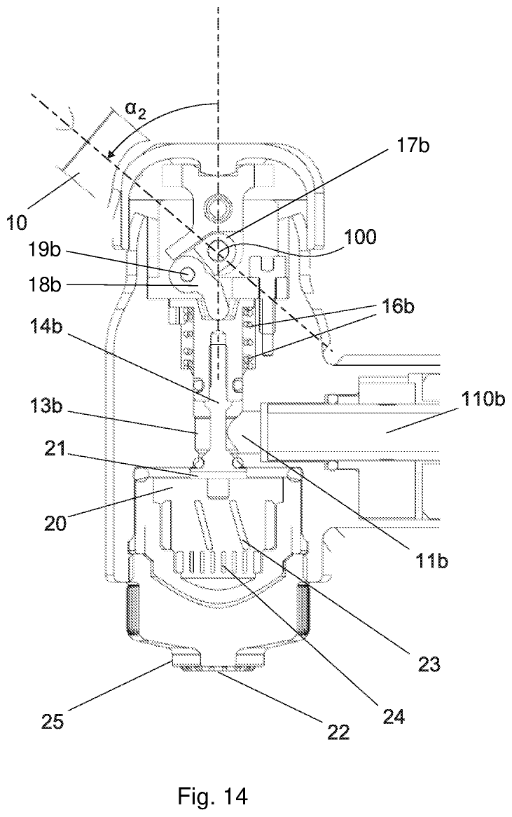

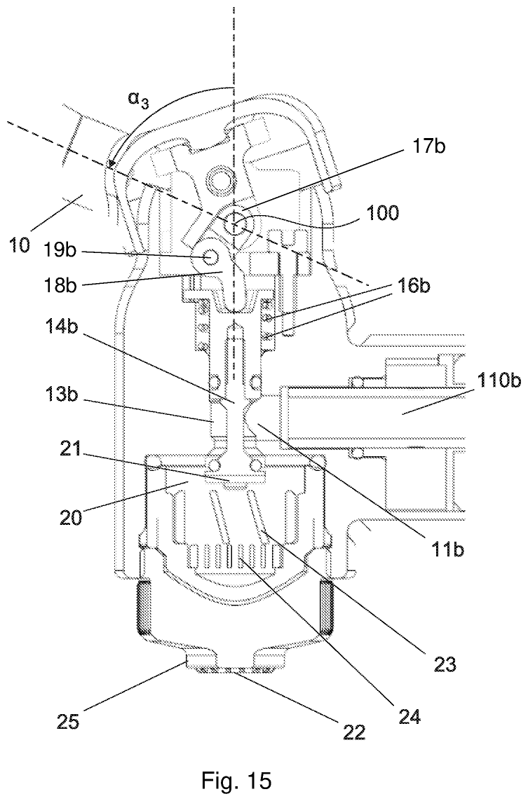

The cross-views of FIGS. 14 and 15 illustrate the toggle mechanism associated to the second piston 14b. Although the reference are only given for this second side of the tap, it shall be understood that the same is true for the other side of the tap (the side corresponding to the first piston). An extremity of the upper plate 17b is fixed around the centre point 100 and is in direct contact with the base of the handle so that a rotation of the handle 10 around the centre point 100 is transferred to the upper plate 17b which also rotates around the centre point. Since the upper and lower plates (17b, 18b) are fixed together through the pivot 19b, the rotation of the upper plate around the centre point causes the lower plate 18b to move. In particular, the lower extremity of the lower plate has a vertical movement component. This lower extremity of the lower plate being disposed on the top of the first or second piston, the vertical movement component of the lower plate cause the first or second piston to move down.

The upper and lower plates associated to the first piston are in an anti-symmetric configuration with respect to the upper and lower plates associated to the second piston. This configuration prevents that both pistons move when the handle is moved. Indeed, this anti-symmetric configuration guarantees that when the handle is put in the first open position, the rotation of the handle only causes the upper plate associated to the first piston to rotate by its contact with the handle base, while the upper plate associated to the second piston is not in contact with the handle base and therefore does not move. Conversely, if the handle is put in the second open position, only the upper plate associated to the second piston is moved by the handle base.

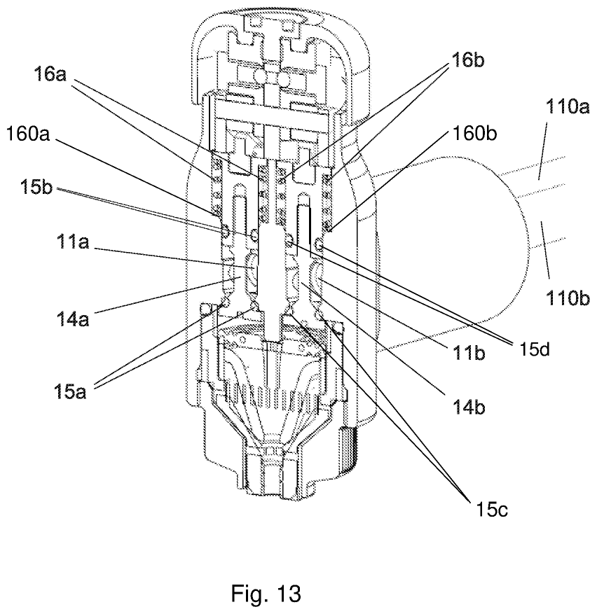

In order to place the pistons back in their upper positions when the handle is moved to the closed position the two pistons can be equipped with springs coiling around them. As illustrated in FIG. 13, a first spring 16a can be mounted around a first portion of the first piston 14a and a second spring can be mounted around a second portion of the second piston 14b.

The inner surface of the first chamber 13a has a first flange 160a on which the first spring 16a can be disposed so that when the first piston is moved down, the first spring is compressed between the upper part of the first piston and the first flange. Then, when the handle is placed back from the first open position to the closed position, the first piston is moved up by the first spring which tends to go back to its equilibrium position. Similarly, The inner surface of the second chamber 13b has a second flange 160b on which the second spring 16b can be disposed so that when the second piston is moved down, the second spring is compressed between the upper part of the second piston and the second flange. Then, when the handle is placed back from the second open position to the closed position, the second piston is moved up by the second spring which tends to go back to its equilibrium position.

The rigidity of the first and second spring may be sufficient to permit to the handle to pass from the first or second open position to the closed position, without the intervention of a user.

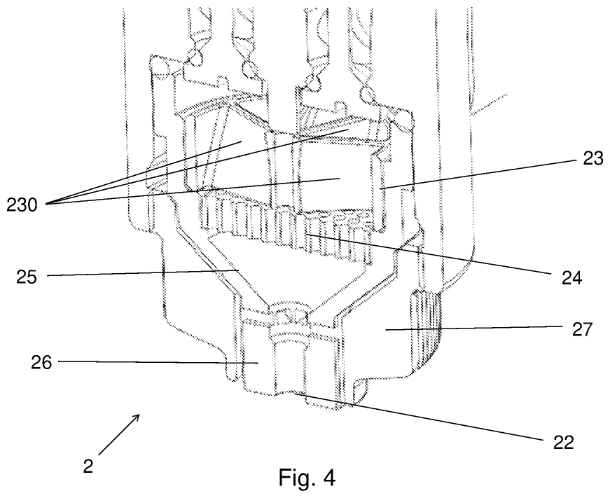

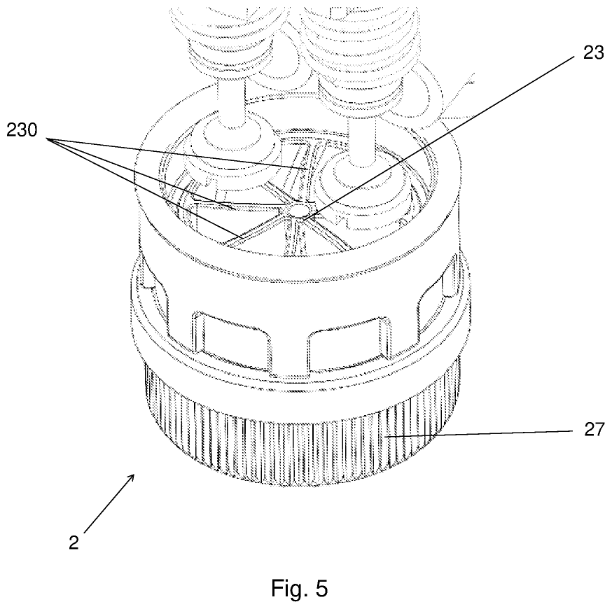

The sealing of the first and second chamber of the tap can be guaranteed by two pairs of O-rings equipped on the two pistons. As illustrated in FIG. 4, the first piston 14a can be equipped with a first lower O-ring 15a which hermetically close the first outlet 12a when the first piston is in the position corresponding to the closed position of the handle. Similarly, the second piston 14b can be equipped with a second lower O-ring 15c which hermetically close the second outlet 12b when the second piston is in the position corresponding to the closed position of the handle.

In addition to the two lower O-rings (15a, 15c), a first upper O-ring 15b can be equipped on the first piston 14a in order to prevent the first liquid from entering in the handle mechanism. Similarly, a second upper O-ring 15d can be equipped on the second piston 14b in order to prevent the second liquid from entering in the handle mechanism.

In a particular embodiment, the external diameters of the first lower O-ring and first upper O-ring are equal. As a consequence of this configuration, when the handle is in the closed position, the pressure applied by the first liquid in the direction of the first lower O-ring is compensated by the pressure applied in the direction of the first upper O-ring. This prevents the first piston to be in an unstable equilibrium when the handle is in the closed position. Similarly, the external diameters of the second lower O-ring and second upper O-ring are equal. As a consequence of this configuration, when the handle is in the closed position, the pressure applied by the second liquid in the direction of the second lower O-ring is compensated by the pressure applied in the direction of the second upper O-ring. This prevents the second piston to be in an unstable equilibrium when the handle is in the closed position.

When the handle is in the first open position, the pressure in the first chamber is usually at an intermediate value between the atmospheric pressure and the pressure in the second pipe. Similarly, when the handle is in the second open position, the pressure in the second chamber is usually at an intermediate value between the atmospheric pressure and the pressure in the second pipe.

In an embodiment, the tap may also comprise one or more solenoid valve activated by the handle for dispensing a predetermined volume of the first or second liquid. Such valves may be disposed in the first and/or second outlet so that only a predetermined amount of the first and/or second liquid can flow in the first and second chambers. Alternatively, the valves could be placed in the first and/or second outlet so that only a predetermined amount of the first and/or second liquid can flow out of the tap.

As already mentioned above, the tap 1 can be equipped with different types of nozzles according to the needs of the user. In particular, the tap can be equipped with an oxygenation nozzle whose purpose is to increase the aeration of the first and second liquids when they flow out of the tap.

The purpose of such a nozzle is therefore to maximize the exchanges between the liquid flowing through the nozzle and the air contained in the nozzle.

A cross section of a tap nozzle 2 for oxygenating at least one liquid is illustrated in FIG. 4. The tap nozzle comprises a nozzle chamber which is in fluid communication with a nozzle inlet 21 adapted to be fixed on a tap. In the case of a tap as described above with a first and a second outlet, the nozzle inlet can be mounted so that both the first and second outlet are put in fluid communication with the nozzle inlet.

The tap nozzle 2 also comprises a nozzle outlet 22 which is in fluid communication with the nozzle inlet 21. The nozzle outlet 22 is arranged to allow the liquid to flow out of the nozzle. The nozzle inlet and outlet therefore form a liquid flow circuit. The nozzle chamber 20 can also be part of the liquid flow circuit.

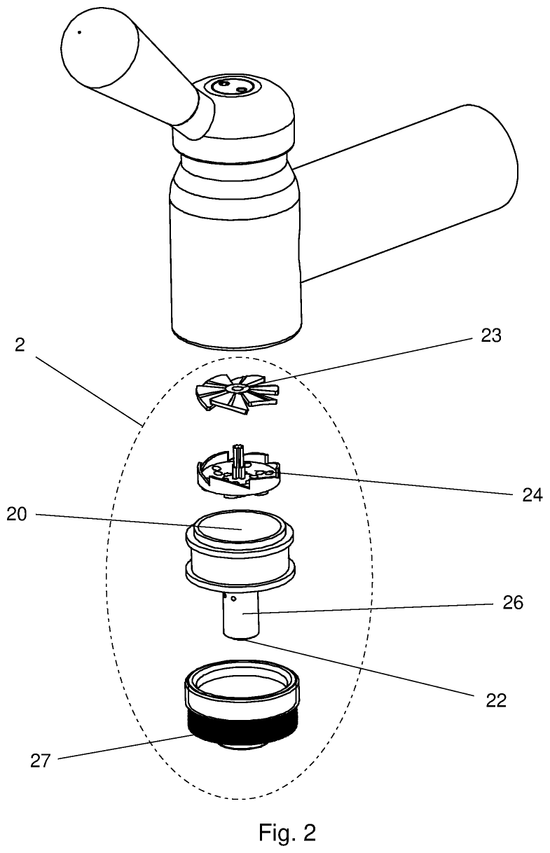

As illustrated in FIG. 2, this oxygenation mechanism comprises a paddle wheel 23 and a planar grid 24 that are disposed consecutively. The paddle wheel is rotatably mounted around a flow axis corresponding to the flowing axis of the liquid in the nozzle. The purpose of the paddle wheel is to maximize the liquid oxygenation by increasing the contact surface between the liquid and an air flow in the nozzle chamber. The planar grid 24 first ensures that bubbles in the liquid having a diameter superior to the holes in the grid are broken, and secondly further maximize the exchange surface between the liquid and the air.

The paddle wheel also causes the liquid to be placed in a vortex configuration.

In order to bring air and therefore oxygen into the liquid, the nozzle 2 comprises an air flow circuit which is dedicated to creating an air flow from the exterior of the nozzle to the interior of the nozzle. This air flow circuit is at least partially distinct from the liquid flow circuit, meaning that the air flow circuit comprises portion in which only air is flowing when the liquid is flowing through the nozzle.

In an embodiment illustrated in FIG. 4, the air flowing in the air flow circuit is brought up to the paddle wheel 23. A portion of the air flow circuit is disposed between an inner lateral surface of the nozzle and an outer lateral surface of the paddle wheel and/or an outer lateral surface of the planar grid. Hence the air is brought directly where the liquid is mixed by the paddle wheel, and where it has a maximal surface of exchange with the air.

The circulation of the air flow can be caused by the flow of the liquid in the nozzle which induces a pressure differential sucking in the air into the air flow circuit.

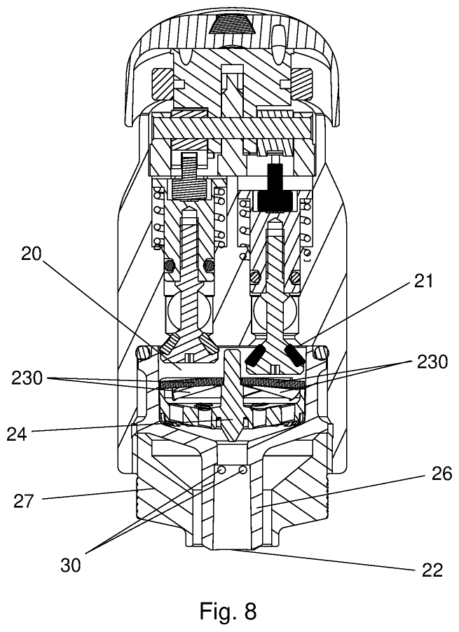

As illustrated in FIGS. 4 and 8, the air flow circuit comprises an air flow inlet 30 which is distinct from the nozzle outlet 22. This air flow inlet 30 is preferentially disposed between the planar grid 24 and the nozzle outlet 22. However, other non-illustrated embodiments can include air flow inlets 30 disposed between the planar grid and the nozzle inlet 21.

In an embodiment illustrated in FIG. 4, the air flow inlet 30 is disposed around the nozzle outlet 22. A cavity allowing the air to flow in the nozzle is disposed around the nozzle outlet 22 so that the air can be sucked in the nozzle.

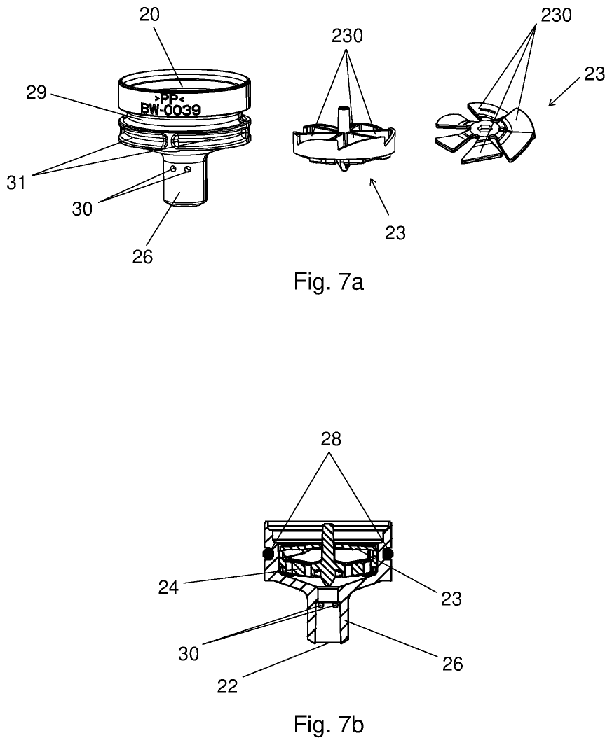

In another embodiment illustrated for example in FIGS. 7b and 8, the air flow inlet 30 is disposed in an outer lateral surface of the nozzle. In this case, the air flow inlet 30 comprise a plurality of holes for sucking in the air into the nozzle using the pressure differential caused by the liquid flowing through the nozzle.

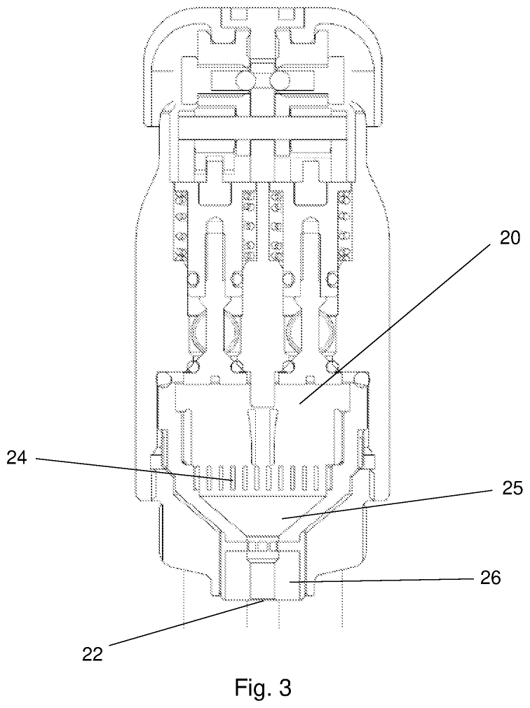

According to an aspect of the invention, the air flow circuit comprises an air flow outlet which is internal to the nozzle. This air flow outlet allows the air flowing into the air flow circuit to enter into the nozzle chamber 20. In some embodiments such as the one illustrated in FIG. 8, the air flow inlet coincide with the air flow outlet and in other embodiments such as the one illustrated in FIG. 3, the air flow inlet is distinct from the air flow outlet.

As illustrated in FIG. 4, the paddle wheel 23 comprises a plurality of fins extending radially from the flow axis so that the rotation of the paddle wheel is caused by the flow of the liquid going through these fins in the manner of a turbine.

The fins of the paddle wheel 23 can be slanted to increase the rotation effect caused by the liquid flow.

As illustrated in FIG. 2, the planar grid 24 is disposed between the paddle wheel 23 and the nozzle outlet 22, in a plane parallel to the plane in which the paddle wheel rotates so that the paddle wheel and the planar grid are parallel. The planar grid comprises a plurality of holes whose diameters may vary or not.

According to another aspect of the invention, the nozzle is also optimized so as to guarantee a high level of hygiene during all phases of use, including, liquid dispensing, washing and maintenance.

In order to prevent external agent such as bacteria or chemicals to enter in the nozzle and in the tap, a nozzle housing 27 can be disposed at least partially around the nozzle. Preferentially, this nozzle housing is fixed in a removeable why so that washing and maintenance is facilitated. As an example, the nozzle housing can be screwed onto an internal nozzle support.

As an example, the nozzle may serve to dispense dechlorinated water for consumption. Due to the low amount of chlore, the water may be particularly prone to bacterial contamination. It is therefore needed to be able to minimize this risk.

Advantageously, the nozzle housing is arranged so that the direct contact between the nozzle housing and the internal parts of the nozzle is reduced to the minimum to avoid direct contamination. Indeed

In an embodiment illustrated in FIGS. 7a and 7b the nozzle comprises an internal support which supports the paddle wheel 23, the planar grid 24. In order to minimize the direct contact between these internal components and the nozzle housing, a nozzle O-ring 28 is disposed in a sealing cavity 29 of the internal support. This nozzle O-ring also prevent a liquid to flow backwards into the nozzle and into the tap to which the nozzle can be attached.

This internal support may additionally comprise lateral slots 31. As illustrated in FIG. 7a, these slots may be cover a given portion of the internal support circumference, for example a slot may cover around a quarter of the circumference of the internal support.

The nozzle with its nozzle housing therefore forms a hygienic system with a clear distinction between the wet zones and the dry zones, minimizing the risk of bacterial or chemical contamination.

In some embodiments, the planar grid 24 is rotatably mounted around the flow axis. This may increase the liquid break occurring in the nozzle to maximize its oxygenation. It may also be used to increase or decrease the speed of the liquid flow in the nozzle according to the particular needs.

When the planar grid 24 is rotatably mounted it may also comprise fins, slanted or not, to further increase the liquid break in the nozzle.

In an embodiment, the paddle wheel 23 and the planar grid 24 are integral one which each other. In other words, the nozzle comprises a rotatably mounted piece which includes both fins and holes.

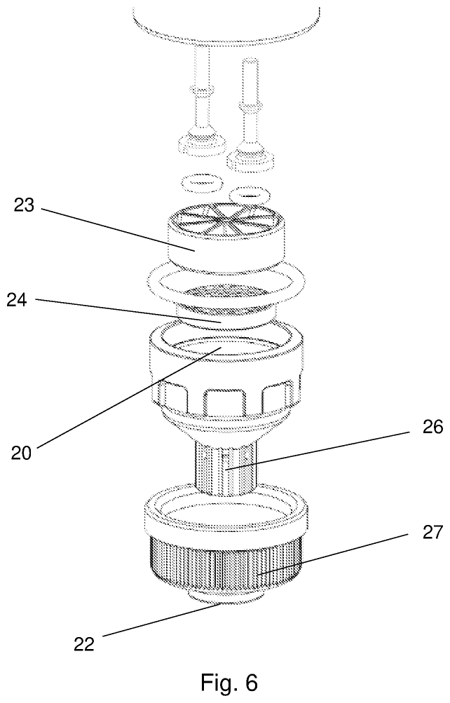

In order to create a venturi effect increasing the amount of air entering into the paddle wheel 23, the tap nozzle 2 may further comprise a funnel 25 disposed between the planar grid 24 and the nozzle outlet 22, as illustrated in FIG. 6. The funnel is oriented so that its aperture with the largest diameter faces towards the planar grid and its aperture with the smallest diameter faces towards the nozzle outlet. Due to the decreasing section of the funnel 25, the pressure is lower at the end of the funnel (i.e. at the aperture with the smallest diameter) than at its entrance (i.e. at the aperture with the largest diameter), so that the liquid and the air that are above the funnel tend to be sucked in into the funnel. This depression naturally maintain the air flow entering into the paddle wheel.

As illustrated in FIGS. 6, 7a and 7b, the tap nozzle 2 may also comprise a liquid flow director 26 for directing the liquid flowing out of the tap nozzle. In this case, the nozzle outlet 22 is at the lower extremity of the liquid flow director.

In the case where the nozzle comprises a nozzle housing 27, the liquid flow director is advantageously arranged so that there is no direct contact between the nozzle housing and the liquid flow director to prevent contamination by contact.

The tap nozzle 2 may be adapted to almost any tap type and is not restricted to the tap described above. In particular, the tap nozzle can be equipped on standard domestic water taps or professional taps dispensing a one or more liquids.

An aspect of the present disclosure also concerns a tap 1 for dispensing a first liquid and/or a second liquid, the tap comprising:
a first inlet 11a that is arranged to be connected to a first pipe 110a for inflowing said first liquid in the tap, and a second inlet 11b that is arranged to be connected to a second pipe 110b for inflowing said second liquid in the tap 1;
a first outlet 12a for outflowing said first liquid and a second outlet 12b for outflowing said second liquid from the tap,
a handle 10 for controlling the flow of the first and/or second liquid through the first and/or second outlet 12a, 12b, wherein the handle 10 is able to rotate around a centre point 100 so as to be placed alternatively in:
a first open position corresponding to a rotation of the handle 10 of a first angle α₁ with respect to a vertical reference axis 101 passing through said centre point, said first open position allowing the first liquid to flow out through the first outlet 12a, or in;
a closed position corresponding to a rotation of the handle 10 of a second angle α₂ with respect to said reference axis 101, said closed position preventing the first or second liquid to flow out from the first and second outlets 12a, 12b, or in;
a second open position corresponding to a rotation of the handle 10 of a third angle α₃ with respect to said reference axis 101, said second open position allowing the second liquid to flow out through the second outlet 12b,
   wherein the first angle α₁ is smaller than the second angle α₂, and wherein the second angle α₂ is smaller than the third angle α₃.

The value of the first angle α₁ can be comprised between 25° and 35°, preferably about 30°, the value of the second angle α₂ can be comprised between 40° and 50°, preferably 45°, and the value of the third angle α₃ can be comprised between 55° and 65°, preferably 60°.

The tap may further comprise
a first chamber 13a which is in fluid communication with the first inlet 11a and with the first outlet 12a, and;
a first piston 14a disposed in the first chamber 13a, the first piston being able to move along a first piston axis between a first hermetic position obstructing the first outlet 12a preventing the first liquid to flow out of the first outlet, and a first flowing position liberating the first outlet 12a allowing the first liquid to flow out of the first outlet, in response to a first movement of the handle 10, and;
a second chamber 13b in fluid communication with the second inlet 11b and with the second outlet 12b, and;
a second piston 14b disposed in the second chamber 13b, the second piston being able to move along a second piston axis between a second hermetic position obstructing the second outlet 13b preventing the second liquid to flow out of the second outlet and a second flowing position liberating the second outlet 12b allowing the second liquid to flow out of the second outlet, in response to a second movement of the handle 10, wherein the first and second hermetic positions of the first and second pistons 14a, 14b correspond to said closed position of the handle 10, and;
   wherein the first flowing position of the first piston corresponds to said first open position of the handle, and;
   wherein the second flowing position of the second piston corresponds to said second open position of the handle.

The tap may further comprise a toggle mechanism relating the handle 10 to the first and second piston, the toggle mechanism allowing to convert a rotation of the handle into a linear movement of the first and/or second piston 14a, 14b.

The tap may further comprise a first lower O-ring 15a and a first upper O-ring 15b that are mounted on the first piston 14b, the first lower O-ring being disposed so as to hermetically obstruct the first outlet 12a when the handle is in the second position, and the first upper O-ring being disposed so as to prevent the first liquid to reach a handle mechanism, and further comprising a second lower O-ring 15c and a second upper O-ring 15d that are mounted on the second piston 14b, the second lower O-ring being disposed so as to hermetically obstruct the second outlet 12b when the handle is in the second position, and the second upper O-ring being disposed so as to prevent the second liquid to reach the handle mechanism.

A first lower external diameter of the first lower O-ring 15a and a first upper external diameter of the first upper O-ring 15b can be equal, and/or wherein a second lower external diameter of the second lower O-ring 15c and a second upper external diameter of the second upper O-ring 15d can be equal.

The tap may further comprise
a first spring 16a that is coiled up around a first portion of said first piston 14a, and
a second spring 16b that is coiled up around a second portion of said second piston 14b,
   wherein said first spring (16a) is compressed when the handle 10 is moved from the close position to the first open position, and wherein said second spring 16b is compressed when the handle 10 is moved from the close position to the second open position.

The tap may further comprise at least one solenoid valve activated by the handle 10 for dispensing a predetermined volume of the first or second liquid.

The tap may further comprise a tap nozzle 2 that comprises:
a nozzle chamber 20;
at least one nozzle inlet 21 in fluid communication with the nozzle chamber, the nozzle inlet being arranged to be connected to a tap outlet for allowing at least one liquid to flow from the tap outlet into the nozzle chamber 20;
a paddle wheel 23 in the nozzle chamber 20, the paddle wheel being able to rotate in a plane perpendicular to a flow axis determined by the flow of the liquid in the nozzle chamber, a rotation of the paddle wheel being caused by the flow of the liquid through a plurality of slanting fins 230 extending radially from the flow axis in the paddle wheel 23;
a nozzle outlet 22 in fluid communication with the nozzle chamber for allowing the at least one liquid to flow out the tap nozzle 2;
a planar grid 24 disposed in the nozzle chamber 20 between the paddle wheel 23 and the nozzle outlet 22 in a plane perpendicular to the flow axis,
   wherein a diameter of the paddle wheel 23 and a diameter of the planar grid 24 are smaller than a diameter the nozzle chamber 20 so as to allow the pressure differential caused by the liquid flow in the nozzle chamber to make an air flow to circulate in between a nozzle chamber inner surface and a paddle wheel lateral outer surface and a planar grid lateral outer surface.

The tap may further comprise a funnel 25 disposed between the planar grid 24 and the nozzle outlet 22 so that an aperture of the funnel having the largest diameter faces the planar grid and an opposite aperture of the funnel having the smallest diameter faces the nozzle outlet.

The tap may further comprise a liquid flow director 26 disposed in the nozzle outlet 22 for directing the liquid flowing out of the tap nozzle 2.

Another aspect of the present disclosure concerns a tap nozzle 2 comprising
a nozzle chamber 20;
at least one nozzle inlet 21 in fluid communication with the nozzle chamber 20, the nozzle inlet being arranged to be connected to a tap outlet for allowing at least one liquid to flow from the tap outlet into the nozzle chamber;
a paddle wheel 23 in the nozzle chamber 20, the paddle wheel being able to rotate in a plane perpendicular to a flow axis determined by the flow of the liquid in the nozzle chamber, a rotation of the paddle wheel being caused by the flow of the liquid through a plurality of slanting fins 230 extending radially from the flow axis in the paddle wheel 23;
a nozzle outlet 22 in fluid communication with the nozzle chamber for allowing the at least one liquid to flow out the tap nozzle 2;
a planar grid 24 disposed in the nozzle chamber 20 between the paddle wheel 23 and the nozzle outlet 22 in a plane perpendicular to the flow axis,
   wherein a diameter of the paddle wheel 23 and a diameter of the planar grid 24 are smaller than a diameter the nozzle chamber so as to allow the pressure differential caused by the liquid flow in the nozzle chamber to make an air flow to circulate in between a nozzle chamber inner surface and a paddle wheel lateral outer surface and a planar grid lateral outer surface.

The tap nozzle of the preceding paragraph may further a funnel disposed between the planar grid 24 and the nozzle outlet 22 so that an aperture of the funnel 25 having the largest diameter faces the planar grid 24 and an opposite aperture of the funnel having the smallest diameter faces the nozzle outlet 22.

The tap nozzle 2 of the last two paragraphs may further comprise a liquid flow director 26 disposed in the nozzle outlet 22 for directing the liquid flowing out of the tap nozzle.

List of reference numerals

| | | | |
|---|---|---|---|
| 1 | Tap | 2 | Tap nozzle |
| 10 | Handle | 20 | Nozzle chamber |
| 100 | Centre point | 21 | Nozzle inlet |
| 11a | First inlet | 22 | Nozzle outlet |
| 11b | Second inlet | 23 | Paddle wheel |
| 110a | First pipe | 230 | Slanting fin |
| 110b | Second pipe | 24 | Planar grid |
| 12a | First outlet | 25 | Funnel |
| 12b | Second outlet | 26 | Liquid flow director |
| 13a | First chamber | 27 | Nozzle housing |
| 13b | Second chamber | 28 | Nozzle O-ring |
| 14a | First piston | 29 | Sealing cavity |
| 14b | Second piston | 30 | Air flow inlet |
| 15a | First lower O-ring | 31 | Lateral slot |
| 15b | First upper O-ring | | |
| 15c | Second lower O-ring | | |
| 15d | Second upper O-ring | | |
| 16a | First spring | | |
| 16b | Second spring | | |
| 160a | First flange | | |
| 160b | Second flange | | |
| 17b | Upper plate | | |
| 18b | Lower plate | | |
| 19b | Pivot | | |

1. A tap nozzle comprising
a nozzle inlet arranged to be connected to a tap outlet for allowing a liquid to flow from the tap outlet into the nozzle;
a nozzle outlet in fluid communication with the nozzle inlet and arranged to allow the liquid to flow out from the nozzle, so as to form a liquid flow circuit;
a paddle wheel rotatably mounted between the nozzle inlet and the nozzle outlet around a flow axis determined by the flow of the liquid in the nozzle, the paddle wheel comprising a plurality of fins extending radially from the flow axis;
a planar grid disposed between the paddle wheel and the nozzle outlet in a plane transverse to the to flow axis;
an air flow circuit allowing an air flow to circulate from the exterior of the nozzle to the interior of the nozzle so as to maximize the liquid oxygenation in the nozzle, the air flow circuit being at least partially distinct from the liquid flow circuit.

2. Tap nozzle according to claim 1, wherein the air flow circuit is at least partially disposed between an internal surface of the nozzle and an outer lateral surface of the paddle wheel and/or an outer lateral surface of the planar grid.

3. Tap nozzle according to claim 1, wherein the air flow circuit comprises an air flow inlet distinct from the nozzle outlet.

4. Tap nozzle according to claim 3, wherein the air flow inlet comprises at least one hole in an outer lateral surface of the nozzle.

5. Tap nozzle according to claim 1, wherein the tap further comprises at least one air flow outlet disposed internally to the nozzle.

6. Tap nozzle according to claim 5, wherein the tap further comprises a nozzle housing.

7. Tap nozzle according to claim 1, wherein the tap further comprises an O-ring disposed between an outer lateral surface of the nozzle and an inner lateral surface of the nozzle housing.

8. Tap nozzle according to claim 1, wherein the fins of the paddle wheel are slanted.

9. Tap nozzle according to claim 1, wherein the planar grid is rotatably mounted around the flow axis.

10. Tap nozzle according to the claim 9, wherein the planar grid comprises fins.

11. Tap nozzle according to claim 9, wherein the paddle wheel and the planar grid are integral one with each other.

12. Tap nozzle according to claim 11, wherein the tap further comprises a funnel disposed between the planar grid and the nozzle outlet so that an aperture of the funnel having the largest diameter faces the planar grid and an opposite aperture of the funnel having the smallest diameter faces the nozzle outlet.

13. Tap nozzle according to claim 1, wherein the tap further comprises a liquid flow director for directing the liquid flowing out of the tap nozzle.

14. Tap nozzle according to claim 1, wherein the tap further comprises a plurality of slots on an outer lateral surface of the nozzle.
